(19) United States
(12) Patent Application Publication
(10) Pub. No.: US 2018/0053461 A1
(43) Pub. Date: Feb. 22, 2018

(54) DISPLAY DEVICE

(71) Applicant: AU Optronics Corporation, Hsin-Chu (TW)

(72) Inventors: Kun-Cheng TIEN, Hsin-Chu (TW); Chien-Huang Liao, Hsin-Chu (TW); Ti-Kuei Yu, Hsin-Chu (TW); Jia-Long Wu, Hsin-Chu (TW)

(21) Appl. No.: 15/659,826

(22) Filed: Jul. 26, 2017

(30) Foreign Application Priority Data
Aug. 18, 2016 (TW) 105126443

(51) Int. Cl. G09G 3/20

(52) U.S. Cl. CPC G09G 3/2074; G09G 3/2092; G09G 3/2003; G09G 2320/0209; G09G 2310/027; G09G 2300/0452; G09G 2320/0285; G09G 2310/0254

(57) ABSTRACT

A display device includes a plurality of first color sub-pixel columns, a plurality of second color sub-pixel columns, a plurality of third color sub-pixel columns, a plurality of gate lines, a plurality of data lines, a gate driver, and a data driver. Each sub-pixel column includes a first type sub-pixel and a second type sub-pixel. Any two adjacent sub-pixels in a same column are electrically connected to different data lines. When grey levels of display data are the same, the data driver provides a first sub-pixel voltage and a second sub-pixel voltage to the first type sub-pixel and the second type sub-pixel respectively. The first sub-pixel voltage is different from the second sub-pixel voltage.

### BACKGROUND

### Technical Field

The present invention relates to a display device, and in particular, to a display device for alleviating color washout.

### Related Art

To resolve a problem of white washout (color washout) at a side viewing angle of a display device, a single sub-pixel is usually divided into two regions, respectively, a primary sub-pixel region and a secondary sub-pixel region, and a suitable circuit drive architecture is used to enable pixel voltages of the two regions of the sub-pixel to be different from each other, such that the single sub-pixel is able to display two degrees of luminance, thereby alleviating white washout at the side viewing angle.

To meet requirements of users for fineness of a picture, display devices tend to have high resolution. If the foregoing sub-pixel region division technology is used in a display device with high resolution, the display device is affected and transmittance of the display device decreases. For example, when M*N pixel units receive display data with a resolution of M*N, a charge sharing circuit may need M scanning lines and M charge sharing control lines to enable pixel voltages of the two regions of the sub-pixel to be different from each other.

Although a special pixel configuration is used in the prior art to overcome the foregoing problem, in the special pixel configuration, how to avoid effects of vertical lines (V-line) or crosstalk (crosstalk) on display quality is a more important issue.

### SUMMARY

A display device disclosed in the present invention comprises a plurality of first color sub-pixel columns, a plurality of second color sub-pixel columns, a plurality of third color sub-pixel columns, a plurality of gate lines, a plurality of data lines, a gate driver, and a data driver, wherein each sub-pixel column comprises a first type sub-pixel and a second type sub-pixel; any two adjacent sub-pixels in a same column are electrically connected to different data lines; when grey levels of display data are the same, the data driver provides a first sub-pixel voltage and a second sub-pixel voltage to the first type sub-pixel and the second type sub-pixel respectively; and the first sub-pixel voltage is different from the second sub-pixel voltage.

Another display device disclosed in the present invention comprises a plurality of first color sub-pixel columns, a plurality of second color sub-pixel columns, a plurality of third color sub-pixel columns, a plurality of gate lines, a plurality of data lines, a gate driver, and a data driver, wherein there are two data lines between any adjacent sub-pixel columns; each sub-pixel column comprises a first type sub-pixel and a second type sub-pixel; two adjacent sub-pixels in a same column are electrically connected to different data lines; when grey levels of display data are the same, the data driver provides a first sub-pixel voltage and a second sub-pixel voltage to the first type sub-pixel and the second type sub-pixel respectively; and the first sub-pixel voltage is different from the second sub-pixel voltage.

In conclusion, a display device having first type sub-pixels and second type sub-pixels for alleviating color washout is used. When a pure color picture is displayed, polarities (or degrees of luminance) of first type sub-pixels in each sub-pixel column are not completely the same and polarities (or degrees of luminance) of second type sub-pixels in each sub-pixel column are not completely the same. The defect of vertical lines (V-line) is overcome by means of zig-zag arrangement of brightness and darkness in a horizontal direction. In addition, the horizontal crosstalk (H-Crosstalk) phenomenon can be alleviated because polarities of first type sub-pixels electrically connected to a same gate line are not completely the same and second type sub-pixels electrically connected to a same gate line are not completely the same.

Both the foregoing description about the present invention and the following detailed description about the embodiments are exemplary and are intended to explain the principles of the present invention, and provide further explanation of the claims of the present invention.

### BRIEF DESCRIPTION OF THE DRAWINGS

FIG. 1A is a schematic diagram of a display device according to an embodiment of the present invention;

FIG. 1B is a schematic diagram of a data driver according to another embodiment of the present invention;

FIG. 2 is a schematic diagram of a display device according to another embodiment of the present invention;

FIG. 3 is a schematic diagram of a display device according to another embodiment of the present invention;

FIG. 4 is a schematic diagram of a display device according to another embodiment of the present invention;

FIG. 5 is a schematic diagram of a display device according to another embodiment of the present invention;

FIG. 6 is a schematic diagram of a display device according to another embodiment of the present invention;

FIG. 7 is a schematic diagram of a display device according to another embodiment of the present invention;

FIG. 8 is a schematic diagram of a display device according to another embodiment of the present invention;

FIG. 9 is a schematic diagram of a display device according to another embodiment of the present invention;

FIG. 10 is a schematic diagram of a display device according to another embodiment of the present invention; and

FIG. 11 is a schematic diagram of a display device according to an embodiment of the present invention.

### DETAILED DESCRIPTION

The detailed features and advantages of the present invention are described below in detail in the following embodiments, and the content of the detailed description is sufficient for persons skilled in the art to understand the technical content of the present invention and to implement the present invention accordingly. Based on the content of the specification, the claims, and the drawings, persons skilled in the art can easily understand the relevant objectives and advantages of the present invention. The following embodiments further describe the viewpoints of the present invention, but are not intended to limit the scope of the present invention in any way. The present invention is further described below with reference to drawings of the specification.

Unless otherwise specified, all the terms as used in the entire specification and claims generally have the same meaning as is commonly understood by persons skilled in the art.

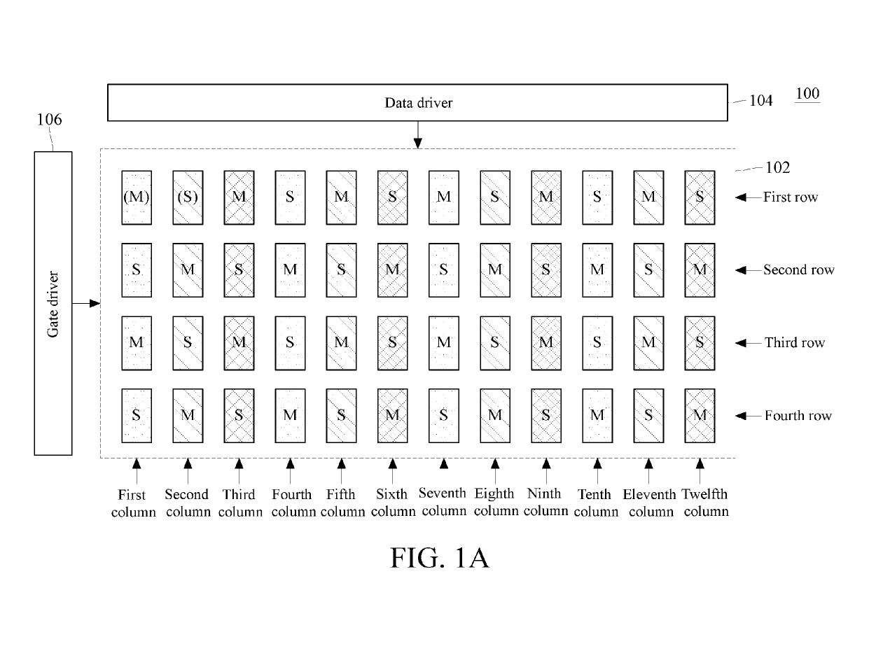

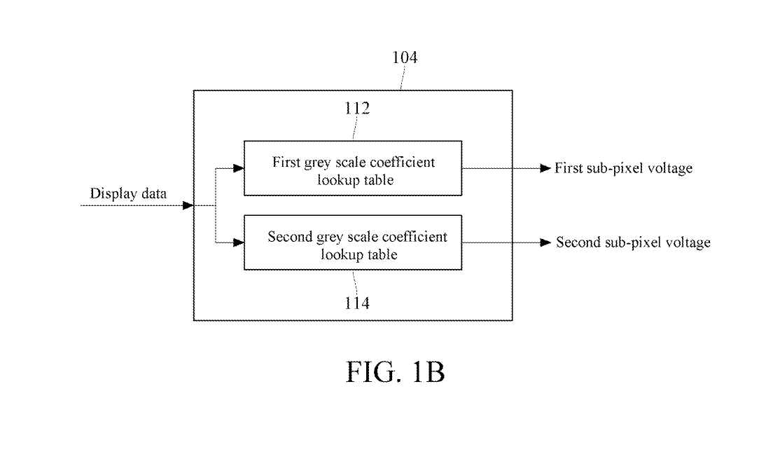

FIG. 1A is a schematic diagram of a display device 100 according to an embodiment of this application. For example, in FIG. 1A, the display device 100 includes a data driver 104, a gate driver 106, and a pixel array 102. The pixel array 102 includes a plurality of pixel units, and the pixel units include red (first color) sub-pixels, green (second color) sub-pixels, and blue (third color) sub-pixels that are sequentially arranged from left to right. The gate driver 106 is configured to output corresponding scanning signals to corresponding pixel units. The data driver 104 is configured to output corresponding pixel voltages to corresponding pixel units.

Further, the data driver 104 is configured to receive display data with a resolution of M*N, and respectively provide corresponding pixel voltages for M*N pixel units. That is, the display device 100 has 3*N columns of sub-pixel units and M rows of pixel units. When the display data is a pure color picture, that is, when grey levels of display data with a same color among M*N display data are the same, pixel voltages provided for units with a same color in the M*N pixel units are not completely the same, so as to alleviate the white washout at a side viewing angle.

As compared with the prior art in which the white washout at a side viewing angle is alleviated by structurally dividing a single sub-pixel into two regions and performing display at different degrees of luminance in the two regions, in this application, the white washout at a side viewing angle is alleviated by providing, by a driver, pixel voltages that are not completely the same for M*N pixel units such that the M*N pixel units displays at degrees of luminance that are not completely the same, instead of dividing a single sub-pixel into two regions. Therefore, as compared with the prior art, this application can improve transmittance of a display panel.

In some embodiments, the display device 100 is of an architecture of arrays extended by using the pixel array 102 as a unit.

FIG. 1B is a schematic diagram of a data driver according to another embodiment of this application. As shown in the figure, a data driver 104 includes a first grey scale coefficient lookup table 112 and a second grey scale coefficient lookup table 114. In respect of operations, the first grey scale coefficient lookup table 112 is used for respectively receiving the display data and providing a plurality of first sub-pixel voltages Vm. In addition, the second grey scale coefficient lookup table 114 is used for respectively receiving the display data and providing a plurality of second sub-pixel voltages Vs. That is, two sub-pixel voltages, respectively, a first sub-pixel voltage Vm and a second sub-pixel voltage Vs, are generated by the driver 104 for each grey level data in the display data. In an embodiment, referring to FIG. 1A, sub-pixels in odd rows and odd columns, that is, first type sub-pixel units (M), receive the first sub-pixel voltages Vm, and sub-pixels in even rows and odd columns, that is, second type sub-pixel units (S), receive second sub-pixel voltages Vs. In an embodiment, any two first type sub-pixel units (M) are not adjacent, and any two second type sub-pixel units (S) are not adjacent. The data driver 104 respectively provides the first sub-pixel voltages Vm and the second sub-pixel voltages Vs for the first type sub-pixel units (M) and the second type sub-pixel units (S), so that the first type sub-pixels (M) and the second type sub-pixels (S) display different degrees of luminance when the display device 100 receives the same display data, so as to alleviate the white washout at a side viewing angle. For example, when the display data received by the display device 100 is red (a pure color picture), the red grey level data are the same. Then, after receiving the red grey level data, the data driver 104 respectively provides the first sub-pixel voltages Vm and the second sub-pixel voltages Vs that are different for the first type sub-pixel units (M) and the second type sub-pixel units (S) of corresponding red sub-pixels. That is, the pixel voltages Vm of the first type sub-pixel units (M) are substantially the same, and the sub-pixel voltages Vs of the second type sub-pixel units (S) are the same. However, the first sub-pixel voltages Vm are different from the second sub-pixel voltages Vs, so that the two type sub-pixel units display different degrees of luminance, so as to alleviate the white washout at a side viewing angle. In addition, because M*N pixel units are used in the present invention to display data with a resolution of M*N, the first type sub-pixel units (M) and the second type sub-pixel units (S) of sub-pixel units of a same column (color) have corresponding display data. For example, in FIG. 1A, a sub-pixel unit in the first column and the first row is a first type sub-pixel unit (M), and corresponding display data thereof is a first grey level GL1. After receiving the first grey level GL1, the data driver 104 generates a first sub-pixel voltage Vm1 and a second sub-pixel voltage Vs1 that are different, and provides the first sub-pixel voltage Vm1 for the first type sub-pixel unit (M). Likewise, a sub-pixel unit in the first column and the second row is a second type sub-pixel unit (S), and corresponding display data thereof is a second grey level GL2. After receiving the second grey level GL2, the data driver 104 generates a first sub-pixel voltage Vm2 and a second sub-pixel voltage Vs2 that are different, and provides the second sub-pixel voltage Vs2 for the second type sub-pixel unit (S). When the first grey level GL1 is different from the second grey level GL2, the first sub-pixel voltage Vm1 is different from the first sub-pixel voltage Vm2, and the second sub-pixel voltage Vs1 is different from the second sub-pixel voltage Vs2.

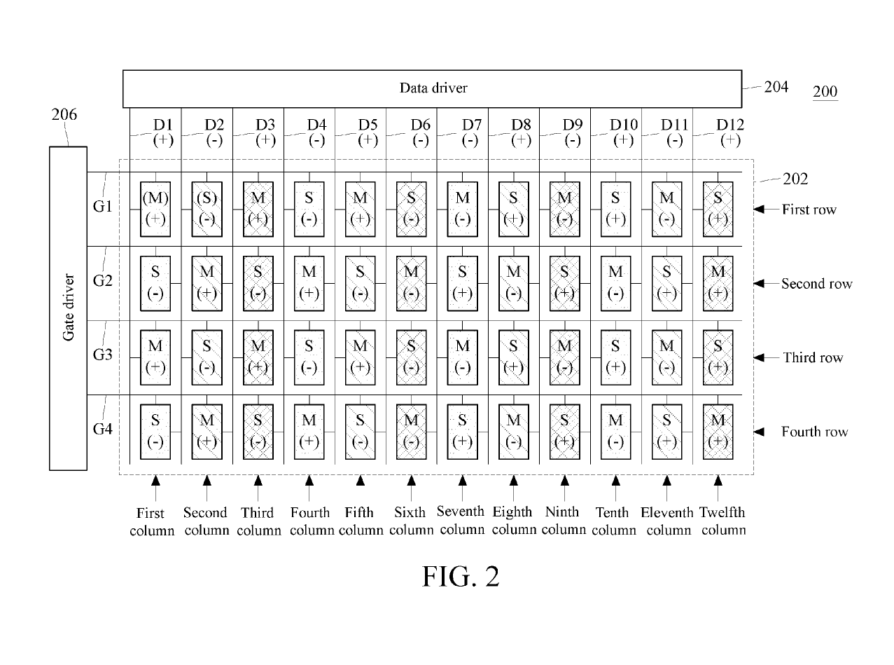

FIG. 2 is a schematic diagram of a display device 200 according to an embodiment of the present invention. For example, in FIG. 2, the display device 200 includes a plurality of data lines D1 to D12, a plurality of scanning lines G1 to G4, and a pixel array 202.

In some embodiments, the display device 200 further includes a data driver 204 and a gate driver 206. The data driver 204 is electrically coupled to the data lines D1 to D12 so as to output corresponding pixel voltages to corresponding data lines. The gate driver 206 is electrically coupled to the scanning lines G1 to G4 so as to output corresponding scanning signals to corresponding scanning lines.

The pixel array 202 includes a plurality of pixel units. For example, in FIG. 2, the pixel units include red (first color) sub-pixels, green (second color) sub-pixels, and blue (third color) sub-pixels that are sequentially arranged from left to right. That is, the pixel array 202 is sequentially provided from left to right with a red sub-pixel column, a green sub-pixel column, a blue sub-pixel column, a red sub-pixel column, a green sub-pixel column, a blue sub-pixel column, and so forth. Sub-pixels in two adjacent rows are electrically connected to different data lines, for example, sub-pixels in two adjacent rows in a same column are electrically connected to different data lines.

For example, in FIG. 2, data lines D1 to D12 are sequentially arranged from left to right. Sub-pixels in odd rows of a red sub-pixel column corresponding to the first column of the pixel array are electrically connected to the data line D1 respectively, sub-pixels in even rows of the red sub-pixel column corresponding to the first column of the pixel array are electrically connected to the data line D2 respectively, sub-pixels in odd rows of a green sub-pixel column corresponding to the second column are electrically connected to the data line D2 respectively, and sub-pixels in even rows of the green sub-pixel column corresponding to the second column are electrically connected to the data line D3 respectively. The rest may be deduced by analogy, and details are not described herein. A display device configured in this manner is also referred to as a zig-zag (Zig-Zag) type display device.

In some embodiments, colors of a first color sub-pixel column, a second color sub-pixel column, and a third color sub-pixel column may respectively be green, red, blue, or any combination of any three colors.

In some embodiments, the pixel unit of the display device 200 also includes a first type sub-pixel (M) and a second type sub-pixel (S). Refer to FIG. 2 for configuration manners of the first type sub-pixels (M) and the second type sub-pixels (S). That is, sub-pixels in odd rows are sequentially configured as M, S, M, and S from left to right, and sub-pixels in even rows are sequentially configured as S, M, S, and M from left to right. That is, any two first type sub-pixels (M) are not adjacent. For example, in a column or a row, any two first type sub-pixels (M) are not adjacent, and any two second type sub-pixels (S) are not adjacent. For example, in a column or a row, any two second type sub-pixels (S) are not adjacent, and the data driver 204 respectively provides first sub-pixel voltages Vm and second sub-pixel voltages Vs for the first type sub-pixels (M) and the second type sub-pixels (S), so that the first type sub-pixels (M) and the second type sub-pixels (S) display different degrees of luminance when the display device 200 receives the same display data, so as to alleviate the white washout at a side viewing angle.

In some embodiments, the display device 200 is of an architecture of arrays extended by using the pixel array 202 as a unit.

In some embodiments, polarities of the data provided by the data lines D1 to D12 are positive (+), negative (−), positive (+), negative (−), positive (+), negative (−), negative (−), positive (+), negative (−), positive (+), negative (−), and positive (+). Therefore, polarities of sub-pixels in odd rows are sequentially, from left to right, positive, negative, positive, negative, positive, negative, negative, positive, negative, positive, negative, and positive, and polarities of sub-pixels in even rows are sequentially, from left to right, negative, positive, negative, positive, negative, negative, positive, negative, positive, negative, positive, and positive.

Further, for the display device 200 of FIG. 2, sub-pixels are configured in a zig-zag (Zig-Zag) manner, and a polarity inversion manner is used for the data lines D1 to D12, the polarities being positive, negative, positive, negative, positive, negative, negative, positive, negative, positive, negative, and positive. Polarities of the first type sub-pixels (M) corresponding to pixel units of the first to the fifth columns are all positive, and polarities of the first type sub-pixels (M) corresponding to pixel units of the sixth to the eleventh columns are all negative. When the received display data is a pure color picture, for example, the display data is displayed as a red picture, polarities of the first type sub-pixels (M) of the first column and the fourth column are all positive, and polarities of the first type sub-pixels (M) of the seventh column and the tenth column are all negative. If levels of common voltages corresponding to a positive-polarity pixel voltage and a negative-polarity pixel voltage that are of a same grey level are different, the degree of luminance of a positive-polarity pixel unit is greater than that of a negative-polarity pixel unit when display data is input at a same grey level. As a result, there is a defect that visually, vertical lines (Vertical-line; V-line) appear in front of human eyes.

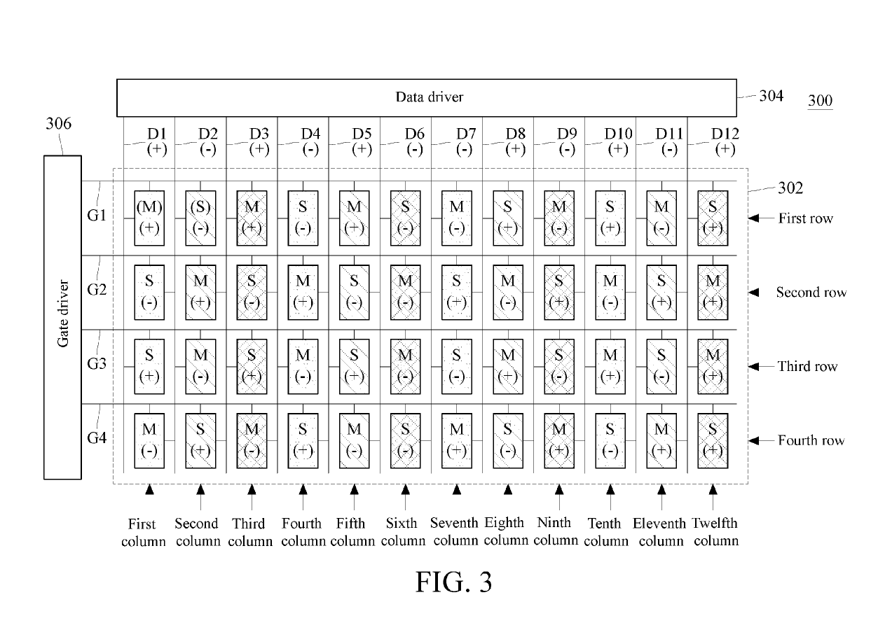

FIG. 3 is a schematic diagram of a display device 300 according to an embodiment of the present invention. The display device 300 has a zig-zag pixel configuration and a polarity inversion manner that are the same as those of the display device 200, and a difference is only that configurations of first type sub-pixels (M) and second type sub-pixels (S) of a third row of the display device 300 are the same as those of a second row, and configurations of first type sub-pixels (M) and second type sub-pixels (S) of a fourth row of the display device 300 are the same as those of a first row. That is, sub-pixels in the first row and the fourth row are sequentially configured as M, S, M, and S from left to right, and sub-pixels in the second row and the third row are sequentially configured as S, M, S, and M from left to right. Polarities of the data provided by the data lines D1 to D12 are positive, negative, positive, negative, positive, negative, negative, positive, negative, positive, negative, and positive. Therefore, polarities of sub-pixels in odd rows are sequentially, from left to right, positive, negative, positive, negative, positive, negative, negative, positive, negative, positive, negative, and positive, and polarities of sub-pixels in even rows are sequentially, from left to right, negative, positive, negative, positive, negative, negative, positive, negative, positive, negative, positive, and positive. By means of changing the foregoing pixel type arrangement manner, when the received display data is a pure color picture, for example, the received display data is displayed as a red picture, polarities of first type sub-pixels (M) in each red sub-pixel column are not completely the same. Therefore, the degrees of luminance of first type sub-pixels (M) of a same red sub-pixel column are not completely the same when the display data is input at a corresponding same grey level. The defect of vertical lines (V-line) is overcome by means of zig-zag arrangement of brightness and darkness in a horizontal direction. Moreover, a data driver 304 respectively provides first sub-pixel voltages Vm and second sub-pixel voltages Vs for the first type sub-pixels (M) and the second type sub-pixels (S), so that the first type sub-pixels (M) and the second type sub-pixels (S) display different degrees of luminance when the display device 300 receives the same display data, so as to alleviate the white washout at a side viewing angle.

In some embodiments, the display device 300 is of an architecture of arrays extended by using a pixel array 302 as a unit.

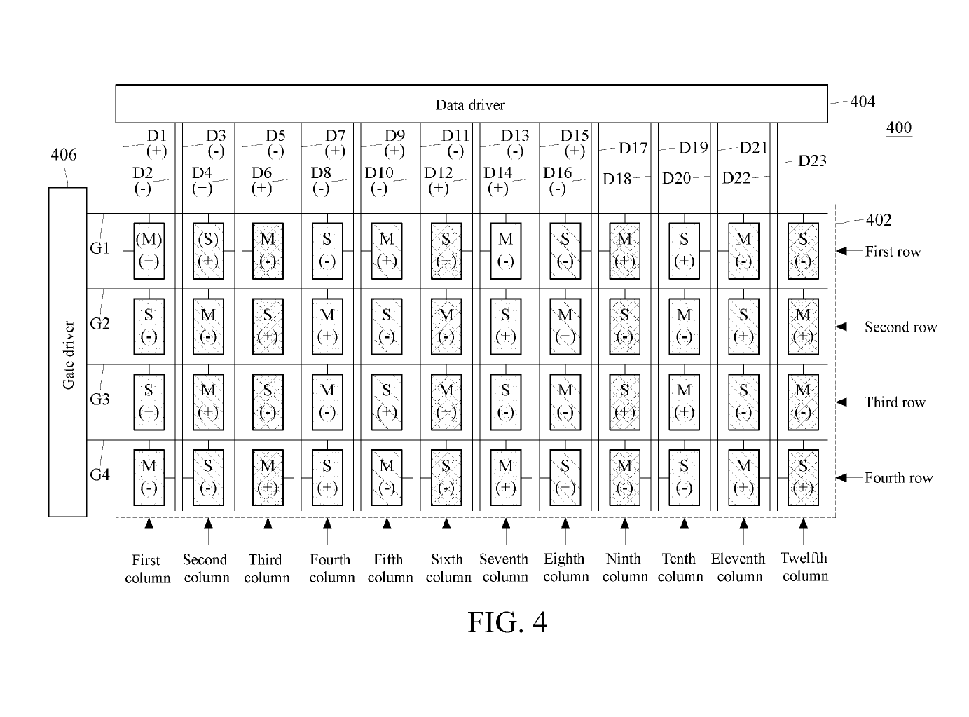

FIG. 4 is a schematic diagram of a display device 400 according to an embodiment of the present invention. For example, in FIG. 4, the display device 400 includes a plurality of data lines D1 to D23, a plurality of scanning lines G1 to G4, and a pixel array 402.

In some embodiments, the display device 400 further includes a data driver 404 and a gate driver 406. The data driver 404 is configured to receive display data with a resolution of M*N, and respectively provide corresponding pixel voltages for M*N pixel units. The pixel array 402 includes a plurality of pixel units. For example, in FIG. 4, the pixel units include red sub-pixels, green sub-pixels, and blue sub-pixels that are sequentially arranged from left to right. Two data lines are configured between any sub-pixels that are adjacent in a horizontal direction, and any sub-pixels that are adjacent in a vertical direction are electrically connected to different data lines. Each data line is only electrically connected to sub-pixels in odd rows or is only electrically connected to sub-pixels in even rows. For example, data lines D1 to D23 are sequentially arranged from left to right. Sub-pixels in odd rows of a red sub-pixel column corresponding to the first column of the pixel array are electrically connected to the data line D1 respectively, sub-pixels in even rows of the red sub-pixel column corresponding to the first column of the pixel array are electrically connected to the data line D2 respectively, sub-pixels in odd rows of a green sub-pixel column corresponding to the second column are electrically connected to the data line D4 respectively, and sub-pixels in even rows of the green sub-pixel column corresponding to the second column are electrically connected to the data line D3 respectively. The rest may be deduced by analogy, and details are not described herein. A display device configured in this manner is also referred to as a zig-zag (Zig-Zag) type display device, and the quantity of data lines is twice the quantity of sub-pixel columns. In this embodiment, the display device 400 is configured with 6*N data lines which are electrically connected to 3*N sub-pixel units respectively, and the display device 400 is configured with M scanning lines which are electrically connected to M rows of pixel units respectively.

In some embodiments, the pixel unit of the display device 400 also includes a first type sub-pixel (M) and a second type sub-pixel (S). Refer to FIG. 4 for configuration manners of the first type sub-pixels (M) and the second type sub-pixels (S). Configurations of first type sub-pixels (M) and second type sub-pixels (S) of a third row are the same as those of a second row, and configurations of first type sub-pixels (M) and second type sub-pixels (S) of a fourth row are the same as those of a first row. That is, types of sub-pixels in the first row and the fourth row are sequentially configured as M, S, M, and S from left to right, and types of sub-pixels in the second row and the third row are sequentially configured as S, M, S, and M from left to right. Configurations of the first type sub-pixels (M) and the second type sub-pixels (S) of the display device 400 are the same as those in FIG. 3. For the pixel array 402, the data driver 404 respectively provides first sub-pixel voltages Vm and second sub-pixel voltages Vs for the first type sub-pixels (M) and the second type sub-pixels (S), so that the first type sub-pixels (M) and the second type sub-pixels (S) display different degrees of luminance when the display device 400 receives the same display data, so as to alleviate the white washout at a side viewing angle.

In some embodiments, polarities of sub-pixels in odd rows of the display device 400 are sequentially, from left to right, positive, positive, negative, negative, positive, positive, negative, and negative, and polarities of sub-pixels in even rows are sequentially, from left to right, negative, negative, positive, positive, negative, negative, positive, and positive. Correspondingly, polarities of data provided by the data lines D1 to D8 are positive, negative, negative, positive, negative, positive, positive, negative, and polarities of data provided by the data lines D9 to D16 are positive, negative, negative, positive, negative, positive, positive, and negative. That is, for the pixel array of the display device 400, a two-dots inversion (two-dots inversion) manner is used for polarity arrangement of the pixel array. By means of the arrangement manner, when the received display data is a pure color picture, for example, the received display data is displayed as a red picture, polarities of first type sub-pixels (M) in each red sub-pixel column are not completely the same. Therefore, the degrees of luminance of first type sub-pixels (M) of a same red sub-pixel column are not completely the same when the display data is input at a corresponding same grey level. The defect of vertical lines (V-line) is overcome by means of zig-zag arrangement of brightness and darkness in a horizontal direction. In addition, the horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

In some embodiments, the display device 400 is of an architecture of arrays extended by using a pixel array 402 as a unit.

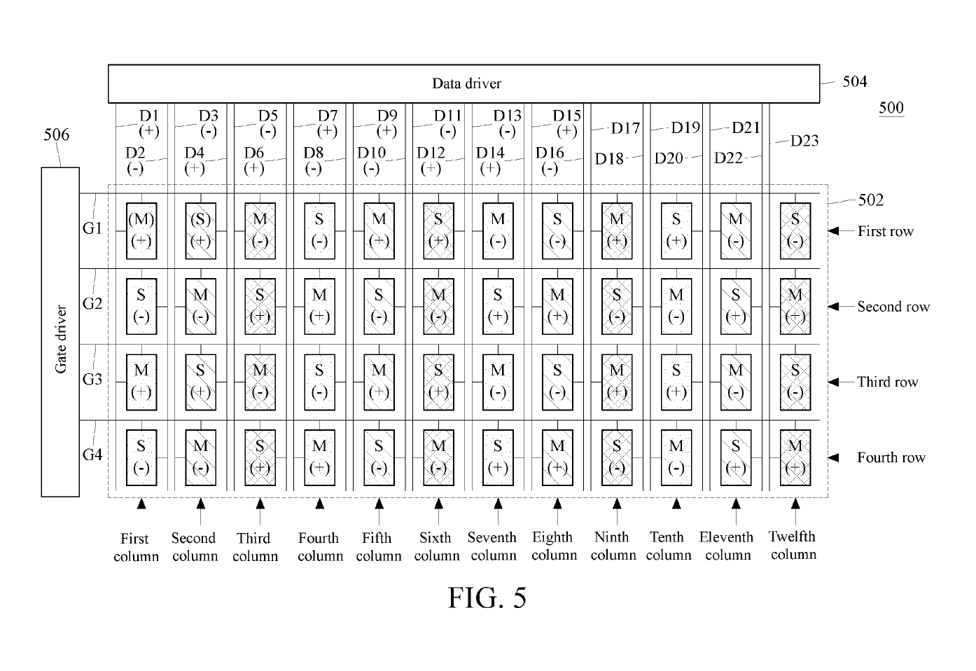

FIG. 5 is a schematic diagram of a display device 500 according to another embodiment of the present invention. The display device 500 has a zig-zag pixel configuration and a polarity inversion manner that are the same as those of the display device 400, and a difference is only that configurations of first type sub-pixels (M) and second type sub-pixels (S) of a third row and fouth row of the display device 500 are slightly different from those of the display device 400. That is, configurations of first type sub-pixels (M) and second type sub-pixels (S) of the third row of the display device 500 are the same as those of a first row, and configurations of first type sub-pixels (M) and second type sub-pixels (S) of a fourth row of the display device 500 are the same as those of a second row. That is, types of sub-pixels in the first row and the third row are sequentially configured as M, S, M, and S from left to right, and types of sub-pixels in the second row and the fourth row are sequentially configured as S, M, S, and M from left to right. Configurations of first type sub-pixels (M) and second type sub-pixels (S) of the display device 500 are the same as those in FIG. 2. For example, in FIG. 5, the display device 500 includes a plurality of data lines D1 to D23, a plurality of scanning lines G1 to G4, and a pixel array 502. The pixel array 502 includes a plurality of pixel units, the pixel units include red sub-pixels, green sub-pixels, and blue sub-pixels that are sequentially arranged from left to right. Two data lines are configured between any pixel units that are adjacent in a horizontal direction, and any pixel units that are adjacent in a vertical direction are electrically connected to different data lines. Each data line is only electrically connected to sub-pixels in odd rows or is only electrically connected to sub-pixels in even rows. For example, data lines D1 to D23 are sequentially arranged from left to right. Sub-pixels in odd rows of a red sub-pixel column corresponding to the first column of the pixel array are electrically connected to the data line D1 respectively, sub-pixels in even rows of the red sub-pixel column corresponding to the first column of the pixel array are electrically connected to the data line D2 respectively, sub-pixels in odd rows of a green sub-pixel column corresponding to the second column are electrically connected to the data line D4 respectively, and sub-pixels in even rows of the green sub-pixel column corresponding to the second column are electrically connected to the data line D3 respectively. The rest may be deduced by analogy, and details are not described herein. A data driver 504 respectively provides first sub-pixel voltages Vm and second sub-pixel voltages Vs for first type sub-pixels (M) and second type sub-pixels (S), so that the first type sub-pixels (M) and the second type sub-pixels (S) display different degrees of luminance when the display device 500 receives the same display data, so as to alleviate the white washout at a side viewing angle.

In some embodiments, polarities of sub-pixels in odd rows of the display device 500 are sequentially, from left to right, positive, positive, negative, negative, positive, positive, negative, and negative, and polarities of sub-pixels in even rows are sequentially, from left to right, negative, negative, positive, positive, negative, negative, positive, and positive. Correspondingly, polarities of data provided by the data lines D1 to D8 are positive, negative, negative, positive, negative, positive, positive, negative, and polarities of data provided by the data lines D9 to D16 are positive, negative, negative, positive, negative, positive, positive, and negative. That is, for the pixel array of the display device 500, a two-dots inversion (two-dots inversion) manner is used for polarity arrangement of the pixel array. By means of the arrangement manner, the horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

In some embodiments, the display device 500 is of an architecture of arrays extended by using a pixel array 502 as a unit.

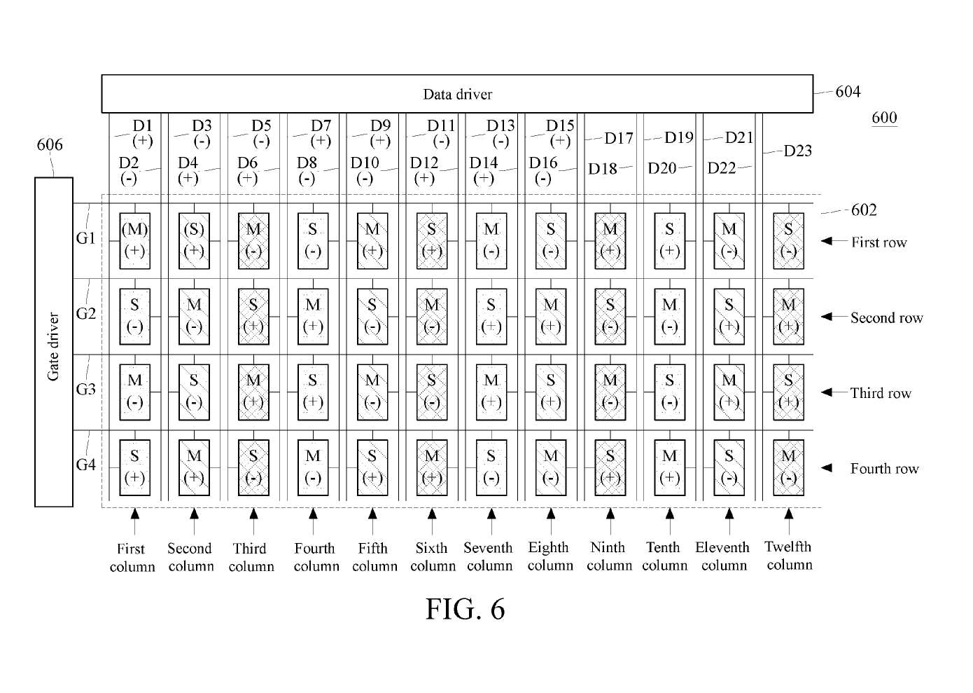

FIG. 6 is a schematic diagram of a display device 600 according to another embodiment of the present invention. Configurations of first type sub-pixels (M) and second type sub-pixels (S) of the display device 600 are the same as those of the display device 500. That is, configurations of first type sub-pixels (M) and second type sub-pixels (S) of a third row of the display device 600 are the same as those of a first row, and configurations of first type sub-pixels (M) and second type sub-pixels (S) of a fourth row of the display device 600 are the same as those of a second row. That is, types of sub-pixels in the first row and the third row are sequentially configured as M, S, M, and S from left to right, and types of sub-pixels in the second row and the fourth row are sequentially configured as S, M, S, and M from left to right. The display device 600 only differs from the display device 500 in that data lines connected to pixels of the third row of the display device 600 are the same as data lines connected to pixels of the second row, and data lines connected to pixels of the fourth row are the same as data lines connected to pixels of the first row. For example, in FIG. 6, the display device 600 includes a plurality of data lines D1 to D23, a plurality of scanning lines G1 to G4, and a pixel array 602. The pixel array 602 includes a plurality of pixel units, and the pixel units include red sub-pixels, green sub-pixels, and blue sub-pixels that are sequentially arranged from left to right. Two data lines are configured between any pixel units that are adjacent in a horizontal direction, and pixel units that are adjacent in a vertical direction are electrically connected to the same data lines. For example, data lines D1 to D23 are sequentially arranged from left to right. Sub-pixels in a first row and a fourth row of a red sub-pixel column corresponding to the first column of the pixel array are electrically connected to the data line D1 respectively, sub-pixels in a second row and a third row of the red sub-pixel column corresponding to the first column of the pixel array are electrically connected to the data line D2 respectively, sub-pixels in a first row and a fourth row of a green sub-pixel column corresponding to the second column are electrically connected to the data line D4 respectively, and sub-pixels in a second row and a third row of the green sub-pixel column corresponding to the second column are electrically connected to the data line D3 respectively. The rest may be deduced by analogy, and details are not described herein. A data driver 604 respectively provides first sub-pixel voltages Vm and second sub-pixel voltages Vs for first type sub-pixels (M) and second type sub-pixels (S), so that the first type sub-pixels (M) and the second type sub-pixels (S) display different degrees of luminance when the display device 600 receives the same display data, so as to alleviate the white washout at a side viewing angle.

In some embodiments, polarities of data provided by the data lines D1 to D8 of the display device 600 are positive, negative, negative, positive, negative, positive, positive, and negative, and polarities of data provided by the data lines D9 to D16 are positive, negative, negative, positive, negative, positive, positive, and negative. Therefore, polarities of sub-pixels in the first row and the fourth row are sequentially, from left to right, positive, positive, negative, negative, positive, positive, negative, and negative, and correspondingly, polarities of sub-pixels in the second row and the third row are sequentially, from left to right, negative, negative, positive, positive, negative, negative, positive, and positive. That is, for the pixel array of the display device 600, a four-dots inversion (four-dots inversion) manner may be used for polarity arrangement of the pixel array. By means of the arrangement manner, when the received display data is a pure color picture, for example, the received display data is displayed as a red picture, polarities of first type sub-pixels (M) in each red sub-pixel column are not completely the same. Therefore, the degrees of luminance of first type sub-pixels (M) of a same red sub-pixel column are not completely the same when the display data is input at a corresponding same grey level. The defect of vertical lines (V-line) is overcome by means of zig-zag arrangement of brightness and darkness in a horizontal direction. The horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

In some embodiments, the display device 600 is of an architecture of arrays extended by using a pixel array 602 as a unit.

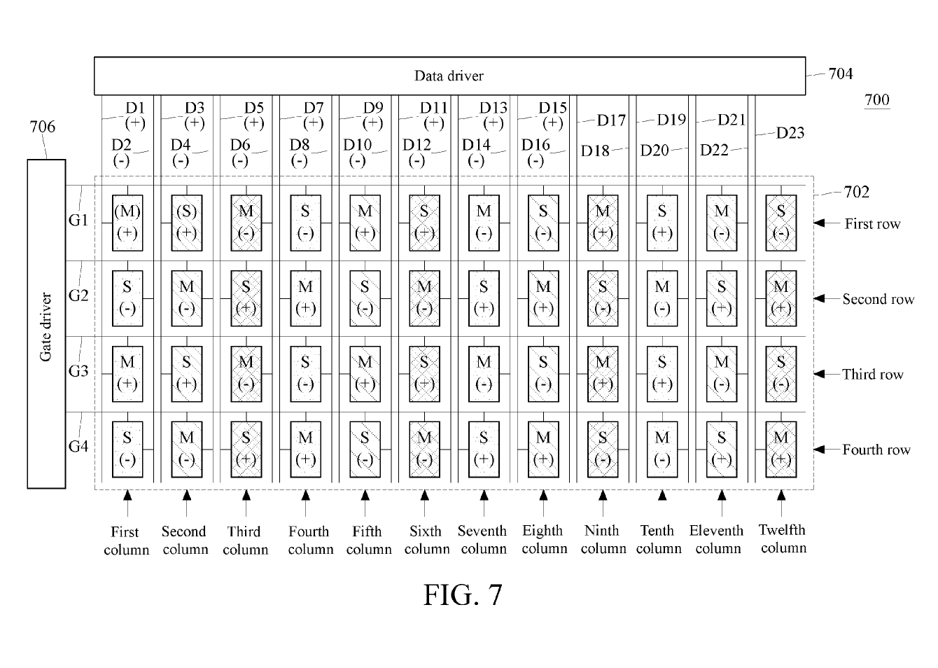

FIG. 7 is a schematic diagram of a display device 700 according to another embodiment of the present invention. Polarities of sub-pixels in odd rows of the display device 700 are sequentially, from left to right, positive, positive, negative, negative, positive, positive, negative, and negative, and correspondingly, polarities of sub-pixels in even rows are sequentially, from left to right, negative, negative, positive, positive, negative, negative, positive, and positive. That is, for the pixel array of the display device 700, a two-dots inversion (two-dots inversion) manner is used for polarity arrangement of the pixel array. In addition, configurations of first type sub-pixels (M) and second type sub-pixels (S) of the display device 700 are the same as those of the display device 600. That is, configurations of first type sub-pixels (M) and second type sub-pixels (S) of a third row of the display device 700 are the same as those of a first row, and configurations of first type sub-pixels (M) and second type sub-pixels (S) of a fourth row of the display device 500 are the same as those of a second row. That is, types of sub-pixels in the first row and the third row are sequentially configured as M, S, M, and S from left to right, and types of sub-pixels in the second row and the fourth row are sequentially configured as S, M, S, and M from left to right. The display device 700 differs from the display device 600 in that configurations of data lines connected to pixel units of the display device 700 are different. For example, in FIG. 7, the display device 700 includes a plurality of data lines D1 to D23, a plurality of scanning lines G1 to G4, and a pixel array 702. The pixel array 702 includes a plurality of pixel units, the pixel units include red sub-pixels, green sub-pixels, and blue sub-pixels that are sequentially arranged from left to right. Two data lines are configured between any pixel units that are adjacent in a horizontal direction, and any pixel units that are adjacent in a vertical direction are electrically connected to different data lines. Each data line is only electrically connected to sub-pixels in odd rows or is only electrically connected to sub-pixels in even rows. For example, data lines D1 to D23 are sequentially arranged from left to right. Sub-pixels in a first row and a third row of a red sub-pixel column corresponding to the first column of the pixel array are electrically connected to the data line D1 respectively, sub-pixels in a second row and a fourth row of the red sub-pixel column corresponding to the first column of the pixel array are electrically connected to the data line D2 respectively, sub-pixels in a first row and a third row of a green sub-pixel column corresponding to the second column are electrically connected to the data line D3 respectively, and sub-pixels in a second row and a fourth row of the green sub-pixel column corresponding to the second column are electrically connected to the data line D4 respectively. The rest may be deduced by analogy, and details are not described herein. That is, a first row and a third row of the pixel array 702 are sequentially connected to adjacent data lines in directions of left, left, right, and right, and a second row and a fourth row of the pixel array 702 are sequentially connected to adjacent data lines in directions of right, right, left, and left. A data driver 704 respectively provides first sub-pixel voltages Vm and second sub-pixel voltages Vs for first type sub-pixels (M) and second type sub-pixels (S), so that the first type sub-pixels (M) and the second type sub-pixels (S) display different degrees of luminance, so as to alleviate the white washout at a side viewing angle.

In some embodiments, polarities of data provided by odd data lines of the display device 700 are positive, and polarities of data provided by even data lines are negative. Therefore, polarities of sub-pixels in the first row and the third row are sequentially, from left to right, positive, positive, negative, negative, positive, positive, negative, and negative, and correspondingly, polarities of sub-pixels in the second row and the fourth row are sequentially, from left to right, negative, negative, positive, positive, negative, negative, positive, and positive. That is, for the pixel array of the display device 600, a two-dots inversion (two-dots inversion) manner is used for polarity arrangement of the pixel array. That is, sub-pixels corresponding to positive polarities are electrically connected to data lines on the left side, and sub-pixels corresponding to negative polarities are electrically connected to data lines on the right side. By means of the arrangement manner, the horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

In some embodiments, the display device 700 is of an architecture of arrays extended by using a pixel array 702 as a unit.

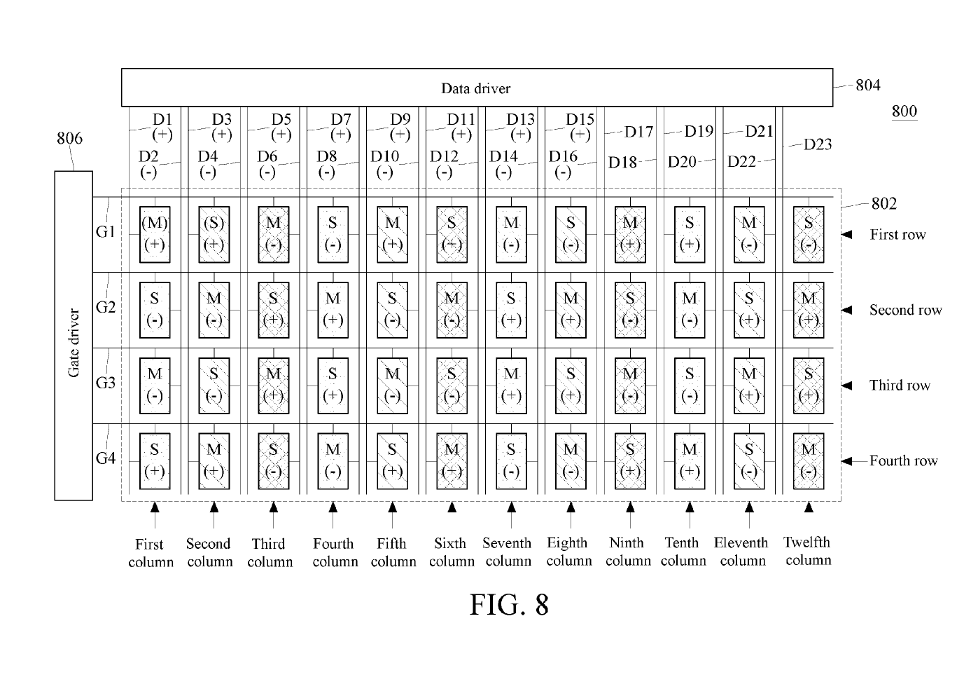

FIG. 8 is a schematic diagram of a display device 800 according to another embodiment of the present invention. Configurations of first type sub-pixels (M) and second type sub-pixels (S) of the display device 800 are the same as those of the display device 700. That is, configurations of first type sub-pixels (M) and second type sub-pixels (S) of a third row of the display device 800 are the same as those of a first row, and configurations of first type sub-pixels (M) and second type sub-pixels (S) of a fourth row of the display device 500 are the same as those of a second row. That is, types of sub-pixels in the first row and the third row are sequentially configured as M, S, M, and S from left to right, and types of sub-pixels in the second row and the fourth row are sequentially configured as S, M, S, and M from left to right. The display device 800 differs from the display device 700 in that configurations of data lines connected to pixel units of the display device 800 are different. For example, in FIG. 8, the display device 800 includes a plurality of data lines D1 to D23, a plurality of scanning lines G1 to G4, and a pixel array 802. The pixel array 802 includes a plurality of pixel units, and the pixel units include red sub-pixels, green sub-pixels, and blue sub-pixels that are sequentially arranged from left to right. Two data lines are configured between any pixel units that are adjacent in a horizontal direction, and data lines D1 to D8 are sequentially arranged from left to right. Sub-pixels in the first row and the fourth row that are corresponding to the first column and the second column of the pixel array 802 are respectively electrically connected to data lines D1 and D3 (electrically connected, to the left, to adjacent data lines), and sub-pixels in the second row and the third row that are corresponding to the first column and the second column of the pixel array 802 are respectively electrically connected to data lines D2 and D4 (electrically connected, to the right, to adjacent data lines). Sub-pixels in the first row and the fourth row that correspond to the third column and the fourth column of the pixel array 802 are respectively electrically connected to data lines D6 and D8, and sub-pixels in the second row and the third row that correspond to the third column and the fourth column of the pixel array 802 are respectively electrically connected to data lines D5 and D7. The rest may be deduced by analogy, and details are not described herein. That is, a first row and a fourth row of the pixel array 802 are sequentially connected to adjacent data lines in directions of left, left, right, and right, and a second row and a third row of the pixel array 802 are sequentially connected to adjacent data lines in directions of right, right, left, and left. A data driver 804 respectively provides first sub-pixel voltages Vm and second sub-pixel voltages Vs for first type sub-pixels (M) and second type sub-pixels (S), so that the first type sub-pixels (M) and the second type sub-pixels (S) display different degrees of luminance when the display device 800 receives the same display data, so as to alleviate the white washout at a side viewing angle.

In some embodiments, polarities of data provided by odd data lines of the display device 800 are positive, and polarities of data provided by even data lines are negative. Therefore, polarities of sub-pixels in the first row and the fourth row are sequentially, from left to right, positive, positive, negative, negative, positive, positive, negative, and negative, and polarities of sub-pixels in the second row and the third row are sequentially, from left to right, negative, negative, positive, positive, negative, negative, positive, and positive. That is, for the pixel array of the display device 800, a four-dots inversion (four-dots inversion) manner may be used for polarity arrangement of the pixel array. That is, sub-pixels corresponding to positive polarities are electrically connected to data lines on the left side, and sub-pixels corresponding to negative polarities are electrically connected to data lines on the right side. By means of the arrangement manner, when the received display data is a pure color picture, for example, the received display data is displayed as a red picture, polarities of first type sub-pixels (M) in each red sub-pixel column are not completely the same. Therefore, the degrees of luminance of first type sub-pixels (M) of a same red sub-pixel column are not completely the same when the display data is input at a corresponding same grey level. The defect of vertical lines (V-line) is overcome by means of zig-zag arrangement of brightness and darkness in a horizontal direction. In addition, the horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

In some embodiments, the display device 800 is of an architecture of arrays extended by using a pixel array 802 as a unit.

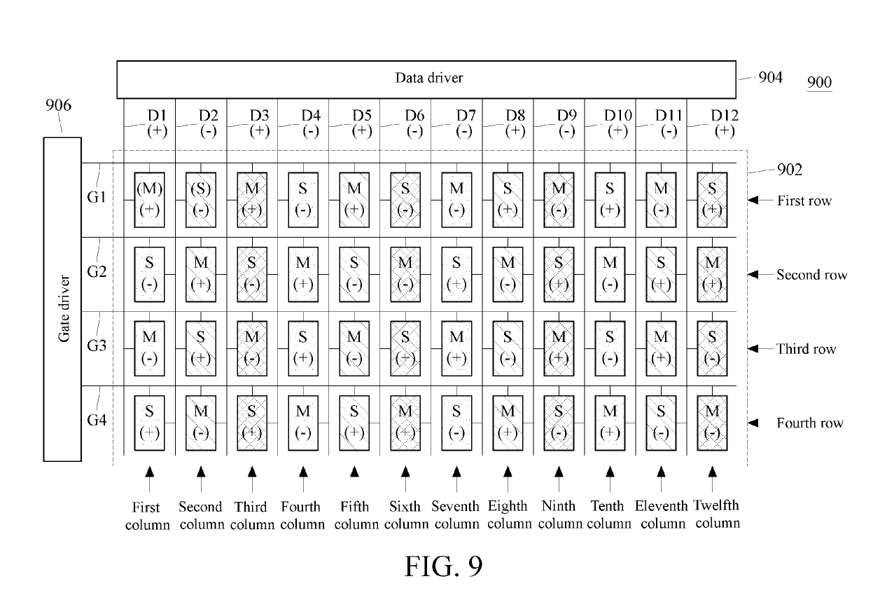

FIG. 9 is a schematic diagram of a display device 900 according to another embodiment of the present invention. For example, in FIG. 9, the display device 900 includes a plurality of data lines D1 to D12, a plurality of scanning lines G1 to G4, and a pixel array 902.

In some embodiments, the display device 900 further includes a data driver 904 and a gate driver 906. The data driver 904 is electrically coupled to the data lines D1 to D12 so as to output corresponding pixel voltages to corresponding data lines. The gate driver 906 is electrically coupled to the scanning lines G1 to G4 so as to output corresponding scanning signals to corresponding scanning lines.

The pixel array 902 includes a plurality of pixel units. For example, in FIG. 9, the pixel units include red (first color) sub-pixels, green (second color) sub-pixels, and blue (third color) sub-pixels that are sequentially arranged from left to right. That is, the pixel array 902 includes a red sub-pixel column, a green sub-pixel column, a blue sub-pixel column, a red sub-pixel column, a green sub-pixel column, and a blue sub-pixel column that are sequentially arranged from left to right, and the rest may be deduced by analogy. Sub-pixels in two adjacent rows are electrically connected to different data lines, for example, sub-pixels in two adjacent rows in a same column are electrically connected to different data lines. For example, in FIG. 9, data lines D1 to D12 are sequentially arranged from left to right. Sub-pixels in odd rows of the red sub-pixel column corresponding to the first column of the pixel array are electrically connected to the data line D1 respectively, sub-pixels in even rows of the red sub-pixel column corresponding to the first column of the pixel array are electrically connected to the data line D2 respectively, sub-pixels in odd rows of the green sub-pixel column corresponding to the second column are electrically connected to the data line D2 respectively, and sub-pixels in even rows of the green sub-pixel column corresponding to the second column are electrically connected to the data line D3 respectively. The rest may be deduced by analogy, and details are not described herein. A display device configured in this manner is also referred to as a zig-zag (Zig-Zag) type display device.

In some embodiments, colors of a first color sub-pixel column, a second color sub-pixel column, and a third color sub-pixel column may respectively be green, red, blue, or any combination of any three colors.

In some embodiments, the pixel units of the display device 900 also include first type sub-pixels (M) and second type sub-pixels (S). Refer to FIG. 2 for configuration manners of the first type sub-pixels (M) and the second type sub-pixels (S). That is, sub-pixels in odd rows are sequentially configured as M, S, M, and S from left to right, and sub-pixels in even rows are sequentially configured as S, M, S, and M from left to right. That is, any two first type sub-pixels (M) are not adjacent. For example, in a column or a row, any two first type sub-pixels (M) are not adjacent, and any two second type sub-pixels (S) are not adjacent. For example, in a column or a row, any two second type sub-pixels (S) are not adjacent, and the data driver 904 respectively provides first sub-pixel voltages Vm and second sub-pixel voltages Vs for the first type sub-pixels (M) and the second type sub-pixels (S), so that the first type sub-pixels (M) and the second type sub-pixels (S) display different degrees of luminance when the display device 900 receives the same display data, so as to alleviate the white washout at a side viewing angle.

This embodiment only differs from the embodiment of FIG. 2 in that polarities of data provided by the data lines D1 to D12 are different. Referring to FIG. 9, corresponding to sub-pixels in the first row and the second row, polarities of the data provided by the data lines D1 to D12 are positive, negative, positive, negative, positive, negative, negative, positive, negative, positive, negative, and positive. Therefore, polarities of sub-pixels in the first row are sequentially, from left to right, positive, negative, positive, negative, positive, negative, negative, positive, negative, positive, negative, and positive, and polarities of sub-pixels in the second row are sequentially, from left to right, negative, positive, negative, positive, negative, negative, positive, negative, positive, negative, positive, and positive. Corresponding to sub-pixels in a third row and a fourth row, polarities of the data provided by the data lines D1 to D12 are negative, positive, negative, positive, negative, positive, positive, negative, positive, negative, positive, and negative. Therefore, polarities of sub-pixels in the third row are sequentially, from left to right, negative, positive, negative, positive, negative, positive, positive, negative, positive, negative, positive, and negative, and polarities of sub-pixels in the fourth row are sequentially, from left to right, positive, negative, positive, negative, positive, positive, negative, positive, negative, positive, negative, and negative. That is, the polarities of the data provided by the data lines D1 to D12 are that inversion is performed once on polarities in each two pixel rows.

Further, for the display device 900 of FIG. 9, sub-pixels are configured in a zig-zag (Zig-Zag) manner, and a manner of performing inversion on each two pixel rows is used for the data lines D1 to D12. By means of the arrangement manner, when the received display data is a pure color picture, for example, the received display data is displayed as a red picture, polarities of first type sub-pixels (M) in each red sub-pixel column are not completely the same. Therefore, the degrees of luminance of first type sub-pixels (M) of a same red sub-pixel column are not completely the same when the display data is input at a corresponding same grey level. The defect of vertical lines (V-line) is overcome by means of zig-zag arrangement of brightness and darkness in a horizontal direction. In addition, the horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

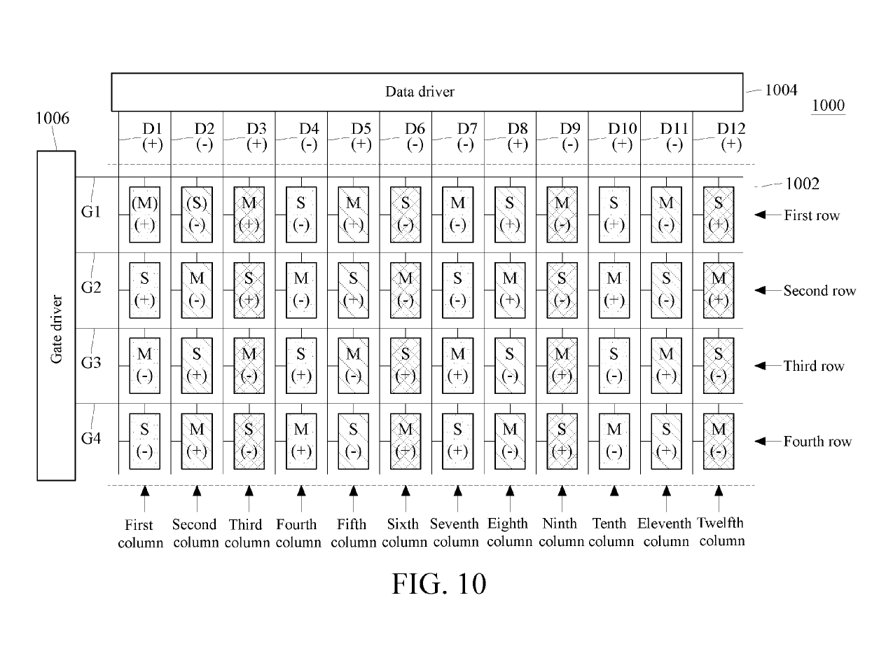

FIG. 10 is a schematic diagram of a display device 1000 according to another embodiment of the present invention. For example, in FIG. 10, the display device 1000 includes a plurality of data lines D1 to D12, a plurality of scanning lines G1 to G4, and a pixel array 1002.

In some embodiments, the display device 1000 further includes a data driver 1004 and a gate driver 1006. The data driver 1004 is electrically coupled to the data lines D1 to D12 so as to output corresponding pixel voltages to corresponding data lines. The gate driver 1006 is electrically coupled to the scanning lines G1 to G4 so as to output corresponding scanning signals to corresponding scanning lines.

The pixel array 1002 includes a plurality of pixel units. For example, in FIG. 10, the pixel units include red (first color) sub-pixels, green (second color) sub-pixels, and blue (third color) sub-pixels that are sequentially arranged from left to right. That is, the pixel array 1002 includes a red sub-pixel column, a green sub-pixel column, a blue sub-pixel column, a red sub-pixel column, a green sub-pixel column, and a blue sub-pixel column that are sequentially arranged from left to right, and the rest may be deduced by analogy. Sub-pixels in a same column are electrically connected to a same data line.

In some embodiments, colors of a first color sub-pixel column, a second color sub-pixel column, and a third color sub-pixel column may respectively be green, red, blue, or any combination of any three colors.

In some embodiments, the pixel unit of the display device 1000 also includes a first type sub-pixel (M) and a second type sub-pixel (S). Refer to FIG. 2 for configuration manners of the first type sub-pixels (M) and the second type sub-pixels (S). That is, sub-pixels in odd rows are sequentially configured as M, S, M, and S from left to right, and sub-pixels in even rows are sequentially configured as S, M, S, and M from left to right. That is, any two first type sub-pixels (M) are not adjacent. For example, in a column or a row, any two first type sub-pixels (M) are not adjacent, and any two second type sub-pixels (S) are not adjacent. For example, in a column or a row, any two second type sub-pixels (S) are not adjacent, and the data driver 1004 respectively provides first sub-pixel voltages Vm and second sub-pixel voltages Vs for the first type sub-pixels (M) and the second type sub-pixels (S), so that the first type sub-pixels (M) and the second type sub-pixels (S) display different degrees of luminance when the display device 1000 receives the same display data, so as to alleviate the white washout at a side viewing angle.

Referring to FIG. 10, corresponding to sub-pixels in the first row and the second row, polarities of the data provided by the data lines D1 to D12 are positive, negative, positive, negative, positive, negative, negative, positive, negative, positive, negative, and positive. Therefore, polarities of sub-pixels in the first row and the second row are sequentially, from left to right, positive, negative, positive, negative, positive, negative, negative, positive, negative, positive, negative, and positive. Corresponding to sub-pixels in a third row and a fourth row, polarities of the data provided by the data lines D1 to D12 are negative, positive, negative, positive, negative, positive, positive, negative, positive, negative, positive, and negative. Therefore, polarities of sub-pixels in the third row and the fourth row are sequentially, from left to right, negative, positive, negative, positive, negative, positive, positive, negative, positive, negative, positive, and negative. That is, the polarities of the data provided by the data lines D1 to D12 are that inversion is performed once on polarities in each two pixel rows.

The configurations of the display device 1000 are combined with the inversion manner of polarities in each two pixel rows of the data lines D1 to D12. By means of the arrangement manner, when the received display data is a pure color picture, for example, the received display data is displayed as a red picture, polarities of first type sub-pixels (M) in each red sub-pixel column are not completely the same. Therefore, the degrees of luminance of first type sub-pixels (M) of a same red sub-pixel column are not completely the same when the display data is input at a corresponding same grey level. The defect of vertical lines (V-line) is overcome by means of zig-zag arrangement of brightness and darkness in a horizontal direction. In addition, the horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

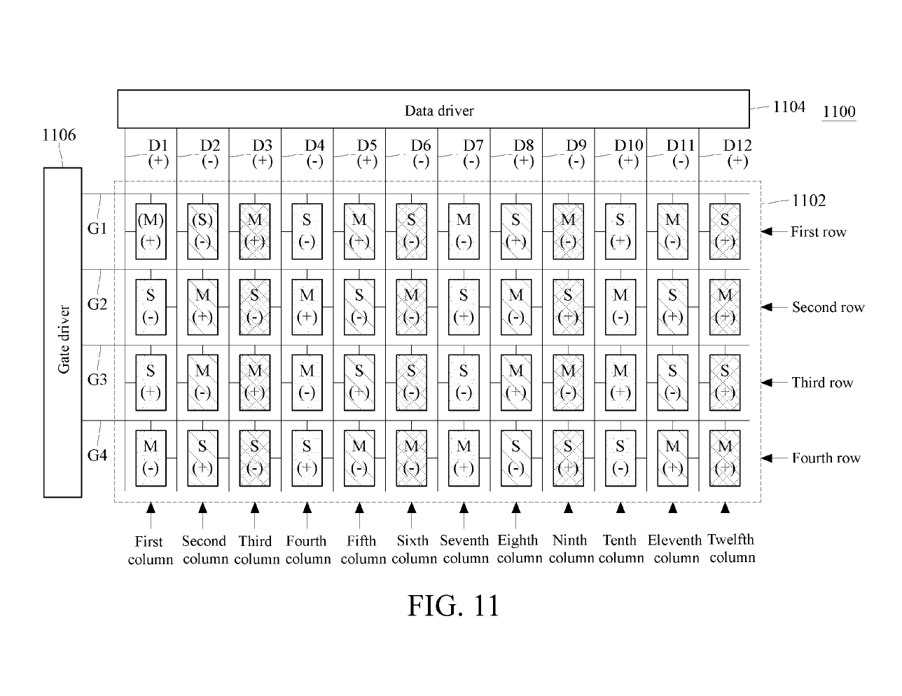

FIG. 11 is a schematic diagram of a display device 1100 according to an embodiment of the present invention. The display device 1100 and the display device 300 have a same zig-zag pixel configuration and a same data line polarity inversion manner, and the display device 1100 only differs from the display device 300 in that configurations of first type sub-pixels (M) and second type sub-pixels (S) of the third row and the fourth row of the display device 1100 are different from those of the display device 300. Referring to FIG. 11, types of sub-pixels in the third row of the display device 1100 are sequentially configured from left to right as S, M, M, M, S, S, S, M, M, M, S, and S. Contrary to the types of sub-pixels in the third row, types of sub-pixels in the fourth row are sequentially configured from left to right as M, S, S, S, M, M, M, S, S, S, M, and M. Polarities of the data provided by the data lines D1 to D12 are positive, negative, positive, negative, positive, negative, negative, positive, negative, positive, negative, and positive. Therefore, polarities of sub-pixels in odd rows are sequentially, from left to right, positive, negative, positive, negative, positive, negative, negative, positive, negative, positive, negative, and positive, and polarities of sub-pixels in even rows are sequentially, from left to right, negative, positive, negative, positive, negative, negative, positive, negative, positive, negative, positive, and positive. By means of changing the foregoing pixel type arrangement manner and combining the 12-period polarity inversion manner, when received display data is a pure color picture, for example, the received display data is displayed as a red picture, polarities of first type sub-pixels (M) in each red sub-pixel column are not completely the same. Therefore, the degrees of luminance of first type sub-pixels (M) of a same red sub-pixel column are not completely the same when the display data is input at a corresponding same grey level. The defect of vertical lines (V-line) is overcome by means of zig-zag arrangement of brightness and darkness in a horizontal direction. Moreover, a data driver 1104 respectively provides first sub-pixel voltages Vm and second sub-pixel voltages Vs for the first type sub-pixels (M) and the second type sub-pixels (S), so that the first type sub-pixels (M) and the second type sub-pixels (S) display different degrees of luminance when the display device 1100 receives the same display data, so as to alleviate the white washout at a side viewing angle.

Again referring to the embodiment of FIG. 3, because polarities of sub-pixels in the sixth column are all negative and polarities of sub-pixels in the twelfth column are all positive, the sub-pixels in the sixth column and the sub-pixels in the twelfth column have types of two adjacent sub-pixels and have the feature that the polarities are the same. That is, the types of sub-pixels corresponding to the sixth column and the twelfth column are sequentially S, M, M, and S. Therefore, when the display device 300 is of an architecture of arrays extended by using the pixel array 302 as a unit and only the third color sub-pixel is transparent, because sub-pixel columns corresponding to a multiple of 6 have the features that two adjacent sub-pixels have the same type and the same polarity, the first type sub-pixels (M) and the second type sub-pixels (S) display different degrees of luminance when the display device 300 receives the same display data (the third color), and at this time, visually, human eyes can easily sense an image defect of plaids.

To overcome the problem, referring to the embodiment of FIG. 11, by means of adjusting types of sub-pixels in the third row and the fourth row, types of any two sub-pixels in the sixth column and the twelfth column are different. In this embodiment, the types of the sub-pixels corresponding to the sixth column and the twelfth column are sequentially S, M, S, and M. The first type sub-pixels (M) and the second type sub-pixels (S) are configured in a zig-zag manner, so as to reduce effects of the plaids.

In conclusion, a display device having first type sub-pixels (M) and second type sub-pixels (S) for alleviating color washout is used. By means of application of the embodiment, when a pure color picture is displayed, polarities (or degrees of luminance) of first type sub-pixels (M) in each sub-pixel column are not completely the same and polarities (or degrees of luminance) of second type sub-pixels (S) in each sub-pixel column are not completely the same. The defect of vertical lines (V-line) is overcome by means of zig-zag arrangement of brightness and darkness in a horizontal direction. In addition, the horizontal crosstalk (H-Crosstalk) phenomenon can be alleviated because polarities of first type sub-pixels (M) electrically connected to a same gate line are not completely the same and second type sub-pixels (S) electrically connected to a same gate line are not completely the same.

This application is disclosed through the foregoing embodiments; however, the embodiments are not intended to limit this application. Various changes and modifications made by persons skilled in the art without departing from the spirit and scope of this application shall fall within the protection scope of this application. Therefore, the protection scope of this application is subject to the appended claims. For example, a conventional display device uses a charge sharing circuit to enable pixel voltages of two regions (a primary sub-pixel region and a secondary sub-pixel region) of a sub-pixel to be different, or distinguishes the sub-pixels into first type sub-pixels (M) and second type sub-pixels (S) and respectively receives corresponding first sub-pixel voltages and second sub-pixel voltages. That is, under this architecture, when display data is at a same grey level, the display device displays four different degrees of luminance, so as to achieve a wide viewing angel and alleviate color washout.

What is claimed is:

1. A display device, comprising:
a first column with a plurality of first color sub-pixels;
a second column with a plurality of second color sub-pixels;
a third column with a plurality of third color sub-pixels;
a plurality of gate lines, for outputting scanning signals to said plurality of first color sub-pixels, said plurality of second color sub-pixels, and said plurality of third color sub-pixels;
a plurality of data lines, for receiving display data and output pixel voltages to said plurality of first color sub-pixels, said plurality of second color sub-pixels, and said plurality of third color sub-pixels;
a gate driver, electrically coupled to the gate lines for driving said plurality of first color sub-pixels, said plurality of second color sub-pixels, and said plurality of third color sub-pixels; and
a data driver, electrically coupled to the data lines for providing data signals for said plurality of first color sub-pixels, said plurality of second color sub-pixels, and said plurality of third color sub-pixels;
wherein each of said first color sub-pixels, second color sub-pixels, and third color sub-pixels is a first type or a second type;
wherein any two adjacent first color sub-pixels are electrically connected to a first data line and a second data line separately;
wherein the data driver provides a first sub-pixel voltage and a second sub-pixel voltage to the sub-pixels in said first type and the sub-pixels in said second type respectively; and
wherein when display data contains one single grey level value, said first sub-pixel voltage is different from said second sub-pixel voltage.

2. The display device according to claim 1, wherein said first color sub-pixels in said first type contains a first polarity and a second polarity, and said first color sub-pixels in said second type contains said first polarity and said second polarity.

3. The display device according to claim 1, wherein said first color sub-pixels in said first type are adjacent to said second color sub-pixels in said second type in each sub-pixel row.

4. The display device according to claim 1, wherein any two adjacent first color sub-pixels in said first type are a first polarity and a second polarity respectively.

5. A display device, comprising:
a plurality of sub-pixels arranged in a first column, a second column, and a third column;
a plurality of gate lines, for outputting scanning signals to said plurality of sub-pixels;
a plurality of data lines, for receiving display data for outputting pixel voltages to said plurality of sub-pixels, wherein said plurality of data lines comprises a first data line and a second data line locating between said first column and said second column;
a gate driver, electrically coupled to the gate lines for driving said plurality of sub-pixels; and
a data driver, electrically coupled to the data lines for providing data signals for said plurality of sub-pixels;
wherein each of said sub-pixels is a first type or a second type;
wherein two adjacent sub-pixels in said first column are electrically connected to said first data line and a second data line respectively;
wherein the data driver provides a first sub-pixel voltage and a second sub-pixel voltage to said sub-pixels in said first type and said second type respectively; and
wherein when display data contains one single grey level value, said first sub-pixel voltage is different from said second sub-pixel voltage.

6. The display device according to claim 5, wherein sub-pixels in said first type and in a first sub-pixel row contain a first polarity and a second polarity.

7. The display device according to claim 5, wherein said sub-pixels in said first column and adjacent sub-pixels in said second column in each sub-pixel row are said first type and said second type respectively.

8. The display device according to claim 5, wherein any two adjacent sub-pixels in said first column and in said first type are a first polarity and a second polarity respectively.

9. The display device according to claim 5, wherein said sub-pixels in said first column and in said first type contains a first polarity and a second polarity, and said sub-pixels in said first column and in said second type contains said first polarity and said second polarity.

10. A display device, comprising:
a plurality of sub-pixels, comprising a first sub-pixel column, a second sub-pixel column, a third sub-pixel column, a fourth sub-pixel column, a fifth sub-pixel column, a sixth sub-pixel column, a seventh sub-pixel column, an eighth sub-pixel column, a ninth sub-pixel column, a tenth sub-pixel column, an eleventh sub-pixel column, and a twelfth sub-pixel column sequentially disposed from left to right;
a plurality of gate lines, for outputting scanning signals to said plurality of sub-pixels;
a plurality of data lines, for receiving display data and outputting pixel voltages to said plurality of sub-pixels, wherein the plurality of data lines comprises twelve successive data lines from left to right;
a gate driver, electrically coupled to said plurality of gate lines for driving said plurality of sub-pixels; and
a data driver, electrically coupled to said plurality of data lines for providing data signals for said plurality of sub-pixels, wherein said data signals for the twelve data lines are positive, negative, positive, negative, positive, negative, negative, positive, negative, positive, negative, and positive;
wherein each of said sub-pixels is a first type or a second type;
wherein the data driver provides a first sub-pixel voltage and a second sub-pixel voltage to said sub-pixels in said first type and said second type respectively; and
wherein when display data contains one single grey level value, said first sub-pixel voltage is different from said second sub-pixel voltage.

11. The display device according to claim 10, wherein sub-pixels in same first column are electrically connected to a first data line; and
wherein any two adjacent sub-pixels in said first column are a first polarity and a second polarity respectively.

12. The display device according to claim 10, wherein each column is electrically connected to more than one data line; and
wherein any two adjacent sub-pixels in the sixth column and the twelfth column are a first polarity and a second polarity respectively.

13. The display device according to claim 10, wherein sub-pixels in each column are electrically connected to more than one data lines; and
wherein each of the sixth column and the twelfth has a single column polarity.

14. The display device according to claim 12, wherein any two adjacent sub-pixels in each column contains said first type and said second type.

15. The display device according to claim 12, wherein both of two adjacent sub-pixels in the sixth column and the twelfth column are either said first type or said second type.

16. The display device according to claim 12, wherein two adjacent sub-pixels in the sixth column and the twelfth column are said first type and said second type respectively.
